(19) United States
(12) Patent Application Publication
(10) Pub. No.: US 2024/0391258 A1
(43) Pub. Date: Nov. 28, 2024

(54) MEDIUM PROCESSING APPARATUS AND RECORDING SYSTEM

(71) Applicant: SEIKO EPSON CORPORATION, TOKYO (JP)

(72) Inventors: Tetsuji YATSUNAMI, Okaya-shi (JP); Yuji MISAWA, Matsumoto-shi (JP); Toshihiro IMAE, Matsumoto-shi (JP)

(21) Appl. No.: 18/795,741

(22) Filed: Aug. 6, 2024

Related U.S. Application Data
(63) Continuation-in-part of application No. 17/498,600, filed on Oct. 11, 2021, now Pat. No. 12,083,795.

(30) Foreign Application Priority Data
Oct. 12, 2020 (JP) 2020-171767

(51) Int. Cl. B41J 11/00; B41J 13/00; B41J 13/03; B41J 25/308; B41J 29/377

(52) U.S. Cl. CPC B41J 11/0024; B41J 13/009; B41J 13/03; B41J 25/308; B41J 29/377

(57) ABSTRACT

A liquid ejecting apparatus includes: a liquid ejecting head that includes a nozzle surface on which a nozzle is open and that ejects a liquid through the nozzle; a housing that accommodates the liquid ejecting head; a moving mechanism that moves the liquid ejecting head relative to the housing in a moving direction intersecting the nozzle surface; and a duct in which a fluid flows, in which the duct includes a first coupling section coupled to the housing and a second coupling section coupled to the liquid ejecting head and is configured to expand and contract in the moving direction.

This application is a continuation in part application of U.S. patent application Ser. No. 17/498,600 filed on Oct. 11, 2021 which claims priority from JP Application Serial Number 2020-171767, filed Oct. 12, 2020. Each of the above-referenced applications is hereby incorporated herein by reference in its entirety.

### BACKGROUND

### 1. Technical Field

The present disclosure relates to a liquid ejecting apparatus such as a printer.

### 2. Related Art

For example, as described in JP-A-2017-140810, recording apparatuses, which are examples of a liquid ejecting apparatus, for performing printing by ejecting ink, which is an example of a liquid, from a recording head, which is an example of a liquid ejecting head, are known. A gap between the recording head and a medium is adjusted when the recording head is raised/lowered relative to the surface on which ink lands.

When a drive element causes a change in pressure of the liquid, the liquid ejecting head ejects the liquid from nozzles. The drive element is driven in accordance with a driving waveform signal generated by a signal generating circuit. The signal generating circuit provided in the liquid ejecting head is able to reduce the influence of noise.

When, for example, a member, such as a signal generating circuit, which generates heat is provided in the liquid ejecting head, the liquid ejecting head is required to be cooled. However, it is difficult to cool a moving liquid ejecting head.

### SUMMARY

A liquid ejecting apparatus includes: a liquid ejecting head that includes a nozzle surface on which a nozzle is open and that ejects a liquid through the nozzle; a housing that accommodates the liquid ejecting head; a moving mechanism that moves the liquid ejecting head relative to the housing in a moving direction intersecting the nozzle surface; and a duct in which a fluid flows, in which the duct includes a first coupling section coupled to the housing and a second coupling section coupled to the liquid ejecting head and is configured to expand and contract in the moving direction.

### BRIEF DESCRIPTION OF THE DRAWINGS

FIG. 1 is a schematic view of a first embodiment of a liquid ejecting apparatus.

FIG. 2 is a schematic view of a liquid ejecting head.

FIG. 3 is a sectional view taken along line III-III in FIG. 2.

FIG. 4 is a sectional view taken along line IV-IV in FIG. 2.

FIG. 5 is a schematic sectional view illustrating a duct in a contracted state.

FIG. 6 is a schematic sectional view of a second embodiment of a duct.

FIG. 7 is a schematic sectional view illustrating the duct in a contracted state.

FIG. 8 is a schematic view of a recording system.

### DESCRIPTION OF EXEMPLARY EMBODIMENTS

### First Embodiment

A first embodiment of a liquid ejecting apparatus will be described below with reference to the drawings. Examples of the liquid ejecting apparatus of the present embodiment include an ink jet printer that ejects ink, which is an example of a liquid, onto a medium, such as a sheet, to perform printing.

In the drawings, on the assumption that a liquid ejecting apparatus 11 is installed on a horizontal surface, the direction of gravity is indicated by the Z-axis, and directions extending horizontally are indicated by the X-axis and the Y-axis. The X-axis, the Y-axis, and the Z-axis are orthogonal to each other. In the following description, a direction parallel to the Y-axis is also referred to as a depth direction Y.

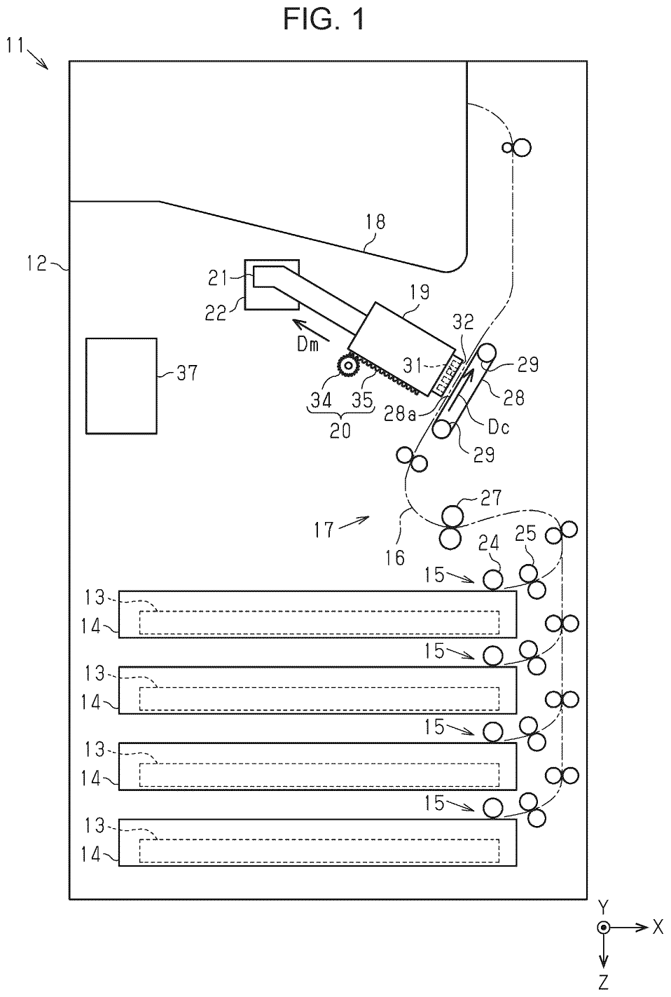

As illustrated in FIG. 1, the liquid ejecting apparatus 11 may include a housing 12, a medium-accommodating section 14 that is able to accommodate a medium 13, and a feeding section 15 that feeds the medium 13. The liquid ejecting apparatus 11 may include a transporting section 17 that transports the medium 13 along a transporting path 16 indicated by the one-dot chain line in the figure and a stacker 18 that receives the medium 13. The transporting path 16 couples the medium-accommodating section 14 and the stacker 18.

The liquid ejecting apparatus 11 includes a liquid ejecting head 19 which ejects liquid, a moving mechanism 20 which moves the liquid ejecting head 19, and a duct 21 in which a fluid flows. The liquid ejecting apparatus 11 may include a pump 22 that feeds a fluid into the duct 21. The housing 12 accommodates at least the liquid ejecting head 19.

The medium-accommodating section 14 is able to accommodate a plurality of media 13 in a stacked manner. The liquid ejecting apparatus 11 may include a plurality of medium-accommodating sections 14 and feeding sections 15 in the same number as the medium-accommodating sections 14. The feeding section 15 may include a feeding roller 24 that feeds the medium 13 accommodated in the medium-accommodating section 14 and a separating section 25 that separates the media 13 one by one. The feeding section 15 transports the medium 13 accommodated in the medium-accommodating section 14 to the transporting path 16.

The transporting section 17 may include a transporting roller 27, an endless transporting belt 28, and a pair of pulleys 29 around which the transporting belt 28 is wound. The transporting section 17 may include a plurality of transporting rollers 27. The transporting rollers 27 transport the medium 13 by rotating in a state of holding the medium 13 therebetween.

The transporting belt 28 has a transporting surface 28a on which the medium 13 is transported. The transporting surface 28a is a planar surface of the outer peripheral surface of the transporting belt 28, which supports the medium 13 through, for example, electrostatic adsorption. The transporting belt 28 may be provided such that the transporting surface 28a is inclined with respect to the horizontal. In the present embodiment, a direction along which the transporting surface 28a extends and in which the medium 13 is transported is a transporting direction Dc. The transporting belt 28 transports the medium 13 in the transporting direction Dc by circulating around the pulleys 29 in a state in which the medium 13 is supported on the transporting surface 28a.

The liquid ejecting head 19 has a nozzle surface 32 on which a plurality of nozzles 31 are open. The nozzle surface 32 is constituted by a nozzle plate in which the nozzles 31 are open. The liquid ejecting head 19 ejects liquid through the nozzles 31 and performs printing on the medium 13. The liquid ejecting head 19 may be provided such that the nozzle surface 32 is inclined with respect to the horizontal. The liquid ejecting head 19 of the present embodiment is of a line type that is able to eject liquid in the width direction of the medium 13. The liquid ejecting head 19 is provided such that the longitudinal direction of the liquid ejecting head 19 extends in the depth direction Y.

The moving mechanism 20 may have a driving gear 34 and a rack 35 provided in the liquid ejecting head 19. The liquid ejecting head 19 and the rack 35 move in accordance with rotation of the driving gear 34. The moving mechanism 20 moves the liquid ejecting head 19 relative to the housing 12 in a moving direction Dm intersecting the nozzle surface 32. The moving direction Dm is a direction in which the liquid ejecting head 19 is separated from the transporting belt 28. The moving direction Dm may be perpendicular to the nozzle surface 32. The moving direction Dm of the present embodiment includes a component of a direction perpendicular to the nozzle plate and is perpendicular to the transporting surface 28a. The moving direction Dm includes a vertical direction component and a horizontal direction component.

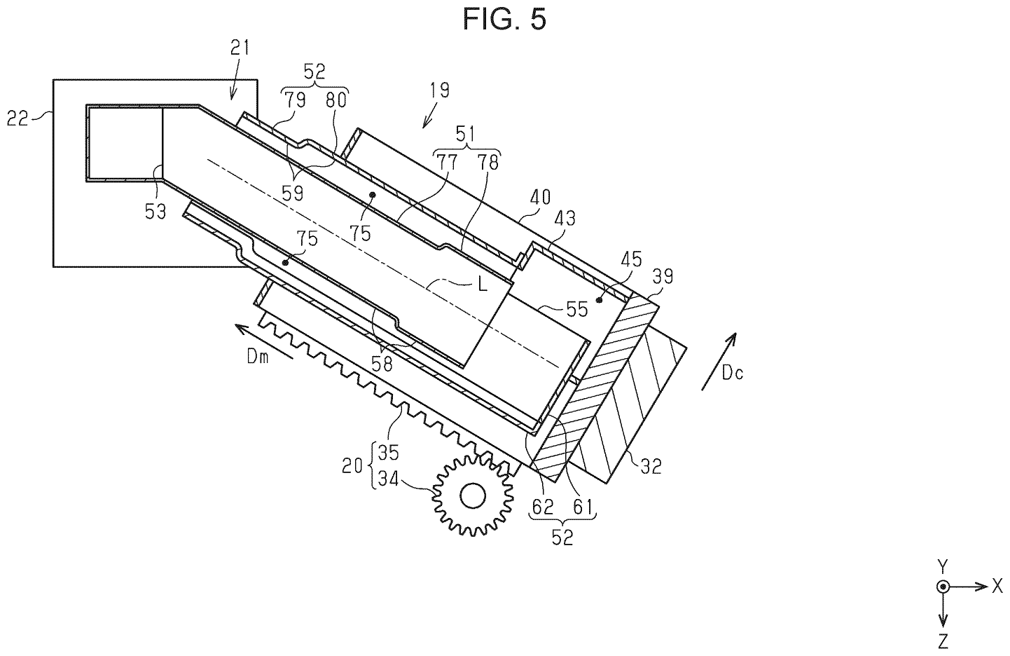

The moving mechanism 20 causes the driving gear 34 to rotate forward and thereby moves the liquid ejecting head 19 in the moving direction Dm. The moving mechanism 20 causes the driving gear 34 to rotate in reverse and thereby moves the liquid ejecting head 19 in a direction opposite to the moving direction Dm. The liquid ejecting head 19 moves between a printing position illustrated in FIG. 1 and a standby position illustrated in FIG. 5. The printing position is a position at which the liquid ejecting head 19 ejects liquid onto the medium 13 to perform printing. The standby position is a position at which the liquid ejecting head 19 stands by at a non-printing time. The liquid ejecting apparatus 11 may include a maintenance section (not illustrated) that performs maintenance of the liquid ejecting head 19 positioned at the standby position.

The liquid ejecting apparatus 11 includes a control section 37 that controls various operations of the liquid ejecting apparatus 11. The control section 37 can be constituted as a circuit including a: one or more processors that execute various types of processing in accordance with a computer program; β: one or more dedicated hardware circuits, such as an application specific integrated circuit, which execute at least some of the various types of processing; or γ: a combination thereof. A processor includes a CPU and memory such as RAM or ROM, and the memory stores program code or commands which cause the CPU to execute processing. The memory, that is, a computer-readable medium, may be any readable medium accessible by using a general-purpose or dedicated computer.

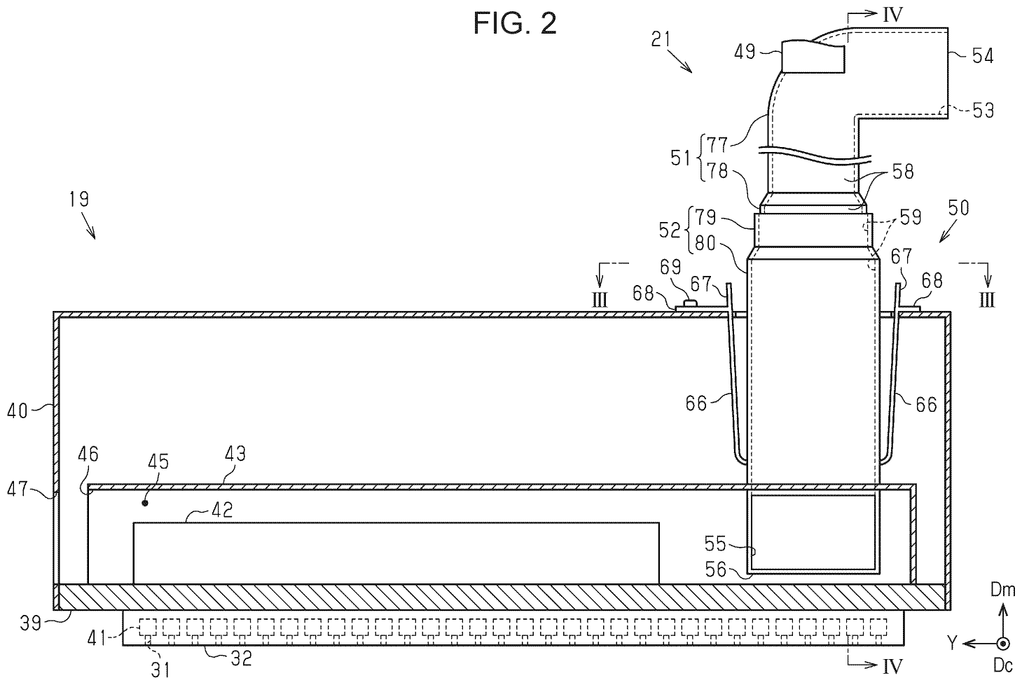

As illustrated in FIG. 2, the liquid ejecting head 19 may include a base 39 and a frame 40. The liquid ejecting head 19 may have a drive element 41, a signal generating circuit 42, and a cover 43 that covers the signal generating circuit 42. The liquid ejecting head 19 may have a plurality of drive elements 41 that correspond to the plurality of nozzles 31. The drive element 41 is driven such that liquid is ejected from the nozzle 31. The signal generating circuit 42 generates a driving waveform signal Com to be applied to the drive element 41. The drive element 41 has, for example, a piezoelectric element and deforms the piezoelectric element in accordance with the driving waveform signal Com, resulting in ejection of liquid from the nozzles.

The cover 43 may form a channel 45, in which a fluid flows, between the base 39 and the cover 43. The duct 21 is coupled to the channel 45 on the rear side thereof further than the center in the depth direction Y, and the channel 45 communicates with the outside via a first opening 46 positioned on the front side further than the center. The frame 40 may have a second opening 47 aligned with the first opening 46 in the depth direction Y. The presence of the second opening 47 enables the fluid in the channel 45 to readily flow. The signal generating circuit 42 is provided in the channel 45. The signal generating circuit 42 is provided between the duct 21 and the first opening 46 in the depth direction Y.

### Duct

The duct 21 has a first coupling section 49 coupled to the housing 12 and a second coupling section 50 coupled to the liquid ejecting head 19. The duct 21 may have a first duct 51 having the first coupling section 49 and a second duct 52 having the second coupling section 50. The duct 21 may have a first end 54 in which an outlet 53 is open and a second end 56 in which an inlet 55 is open. The inlet 55 is coupled to the pump 22. The duct 21 enables the inlet 55 and the outlet 53 to communicate with each other and enables the fluid to flow between the inlet 55 and the outlet 53.

The first duct 51 enables the fluid to flow between the housing 12 and the second duct 52. The first duct 51 of the present embodiment enables the fluid to flow between the pump 22, which is fixed to the housing 12, and the second duct 52. The second duct 52 enables the fluid to flow between the first duct 51 and the liquid ejecting head 19. The second end 56 and the inlet 55 of the second duct 52 are positioned in the channel 45.

The first duct 51 has a first slide surface 58. The first slide surface 58 is the outer surface of the first duct 51. The second duct 52 has a second slide surface 59 that faces the first slide surface 58. The second slide surface 59 is the inner surface of the second duct 52.

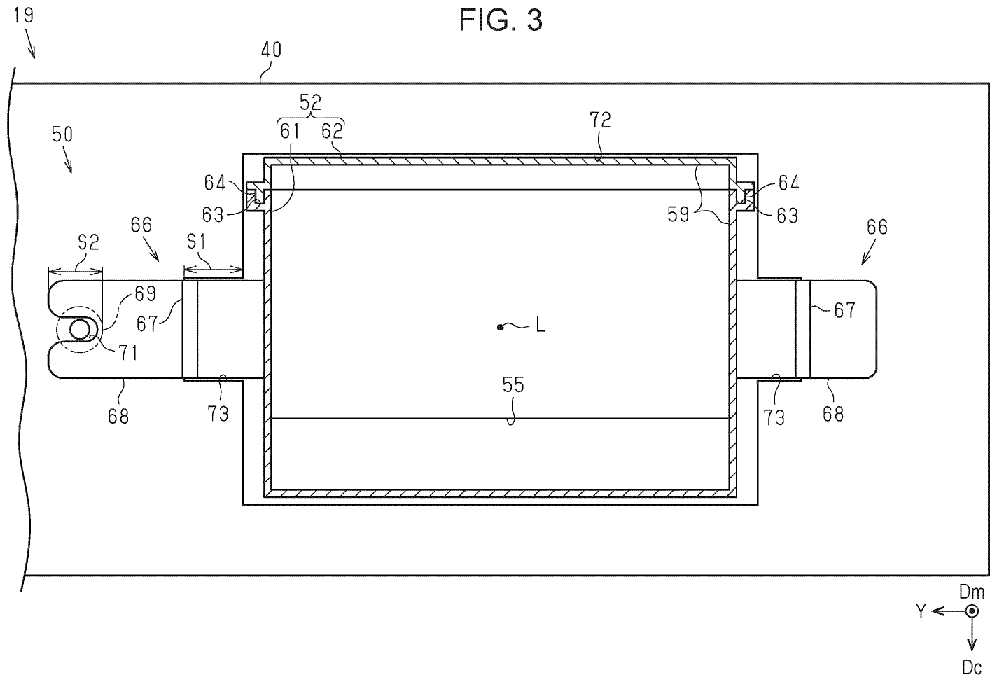

As illustrated in FIGS. 2 and 3, each of the first duct 51 and the second duct 52 is a rectangular cylinder having a rectangular section perpendicular to a virtual straight-line L. Each of the first slide surface 58 and the second slide surface 59 is parallel to the virtual straight-line L and provided so as to encompass the virtual straight-line L. The second duct 52 may slide relative to the first duct 51 in accordance with the liquid ejecting head 19 moving relative to the housing 12.

Of the first slide surface 58 and the second slide surface 59, the first slide surface 58 arranged in an inner portion may be constituted by a single member. Of the first slide surface 58 and the second slide surface 59, the second slide surface 59 arranged in an outer portion may be constituted by plural members.

As illustrated in FIG. 3, the second duct 52 may have a main body 61 having a groove shape and a lid 62. The second slide surface 59 may be constituted by the main body 61 and the lid 62. The second duct 52 may have a groove 63 and a protrusion 64 each extending across a region in which the main body 61 and the lid 62 are coupled to each other. The main body 61 of the present embodiment has the groove 63. The lid 62 has the protrusion 64. When the lid 62 is attached to the main body 61, the protrusion 64 fits into the groove 63.

### Second Coupling Section

As illustrated in FIGS. 2 and 3, the second coupling section 50 is provided between the first end 54 and the second end 56. The second coupling section 50 may have a plate spring 66 having elasticity. That is, the second coupling section 50 may have elasticity. The second coupling section 50 may have a plurality of plate springs 66. The second coupling section 50 of the present embodiment has two plate springs 66 arranged with the second duct 52 therebetween in the depth direction Y. By using the two plate springs 66 arranged in the depth direction Y, the second coupling section 50 enables positional deviation of the second duct 52 in the depth direction Y with respect to the liquid ejecting head 19.

Since the two plate springs 66 have substantially the same configuration, common constituents will be given the same reference numerals, and redundant description will be thereby omitted.

The plate spring 66 may have a handle 67 provided in the tip end of the plate spring 66 and a protrusion 68 placed over the liquid ejecting head 19. The protrusion 68 is provided closer to the tip end of the plate spring 66 than to the base end of the plate spring 66. The handle 67 is a portion between the protrusion 68 and the tip end. When the protrusion 68 is pushed against the liquid ejecting head 19, the plate spring 66 causes the second duct 52 to be coupled to the liquid ejecting head 19. An operator is able to decouple the second duct 52 and the liquid ejecting head 19 by deforming the plate spring 66 so as to bring the handle 67 close to the second duct 52.

The base end of the plate spring 66 may be fixed to the second duct 52, or the plate spring 66 may be formed to be integrated with the second duct 52. The two plate springs 66 are linearly symmetrical with respect to the virtual straight-line L. The virtual straight-line L passes through the center of the second duct 52 and extends in the moving direction Dm. At least one of the plate springs 66 may be fixed to the frame 40 by using a screw 69. In the present embodiment, a single plate spring 66 is fixed.

As illustrated in FIG. 3, the fixed plate spring 66 may have a cut-out 71 through which the screw 69 passes. The cut-out 71 is recessed from the tip end of the protrusion 68. A direction in which the cut-out 71 extends is identical to a direction in which the plate spring 66 deforms to decouple the second coupling section 50.

The frame 40 may have a through hole 72 through which the duct 21 is inserted and a recess 73 into which the plate spring 66 fits. When a first dimension S1 of the recess 73 in the depth direction Y is greater than a second dimension S2 from the tip end of the protrusion 68 to the edge of the screw 69, it is possible to couple or decouple the second coupling section 50 in a state in which the screw 69 is loosened.

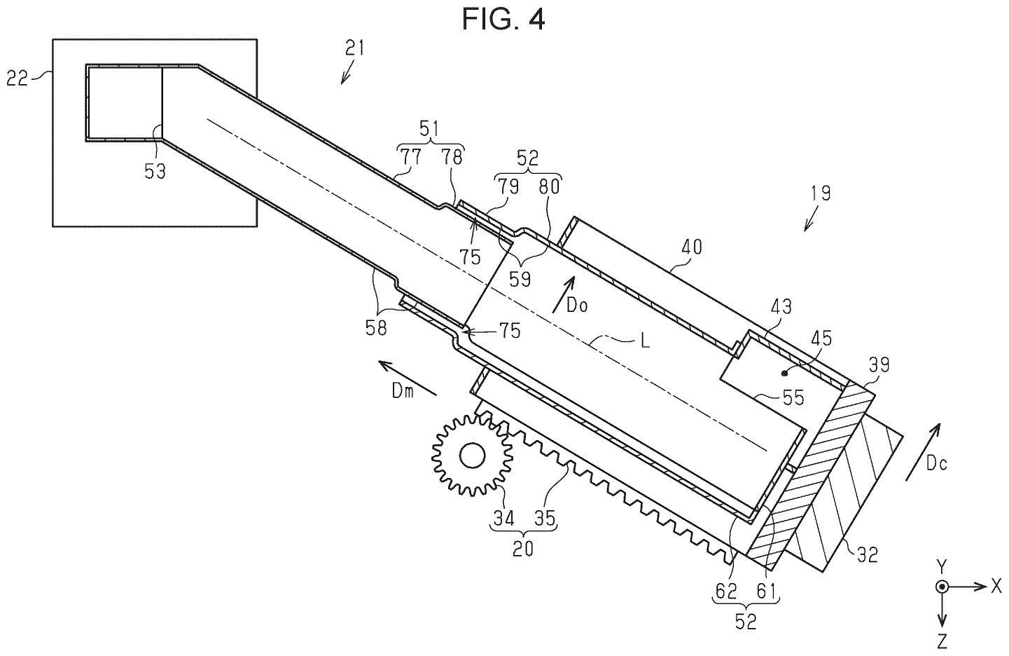

As illustrated in FIG. 4, the first slide surface 58 and the second slide surface 59 may be provided with a gap 75 therebetween, the gap 75 having a sufficient dimension to enable the fluid to pass therethrough. Specifically, the first slide surface 58 and the second slide surface 59 are provided with the gap 75 therebetween in an orthogonal direction Do orthogonal to the virtual straight-line L. The first duct 51 and the second duct 52 are able to move relative to each other in the orthogonal direction Do.

The first duct 51 may have a first thin tube section 77 and a first thick tube section 78 thicker than the first thin tube section 77. The second duct 52 may have a second thin tube section 79 and a second thick tube section 80 thicker than the second thin tube section 79. The first thick tube section 78 is positioned between the first thin tube section 77 and the liquid ejecting head 19 and is thinner than the second thin tube section 79. The second thick tube section 80 is positioned between the second thin tube section 79 and the liquid ejecting head 19. The inlet 55 is provided in the second thick tube section 80. The first slide surface 58 is constituted by the outer surfaces of the first thin tube section 77 and the first thick tube section 78. The second slide surface 59 is constituted by the inner surfaces of the second thin tube section 79 and the second thick tube section 80.

Operation of the present embodiment will be described.

The duct 21 is able to expand and contract in the moving direction Dm. Specifically, the duct 21 expands/contracts when the amount by which the first duct 51 and the second duct 52 overlap is changed.

As illustrated in FIG. 4, when the liquid ejecting head 19 is at the printing position, the amount by which the first duct 51 and the second duct 52 overlap is minimum, and the length of the duct 21 is maximum. In a state in which the liquid ejecting head 19 is at the printing position and in which the duct 21 is expanded, the first thick tube section 78 and the second thin tube section 79 may face each other. The gap 75 is formed between the first thick tube section 78 and the second thin tube section 79.

When the liquid ejecting head 19 moves in the moving direction Dm, the second duct 52 moves in the moving direction Dm together with the liquid ejecting head 19. The amount by which the first duct 51 and the second duct 52 overlap increases in accordance with the movement of the second duct 52.

As illustrated in FIG. 5, when the liquid ejecting head 19 is at the standby position, the amount by which the first duct 51 and the second duct 52 overlap is maximum, and the length of the duct 21 is minimum. In a state in which the duct 21 is contracted, the first thin tube section 77 and the second thin tube section 79 may face each other, and the first thick tube section 78 and the second thick tube section 80 may face each other. The gap 75 is formed between the first slide surface 58 and the second slide surface 59. In the state in which the duct 21 is contracted, a portion of the first thick tube section 78 may be at the same position as the inlet 55 in the moving direction Dm.

The pump 22 may feed the fluid into the duct 21 which may be in the expanded state, the contracted state, or in a state of being deformed. In the present embodiment, when the pump 22 sucks air, which is an example of a fluid, in the duct 21, air which has flowed into the channel 45 from the first opening 46 flows into the duct 21 through the channel 45. That is, not only the duct 21 but also the cover 43 may enable the fluid to flow therein.

Effects of the present embodiment will be described.

The duct 21 coupled to the housing 12 and the liquid ejecting head 19 is able to expand and contract in the moving direction Dm. Accordingly, the duct 21 expands/contracts in response to movement of the liquid ejecting head 19 in the moving direction Dm. It is therefore possible to cool the moving liquid ejecting head 19.

The duct 21 expands/contracts when the second duct 52 slides relative to the first duct 51. It is therefore possible to reduce possible deformation of the duct 21 compared with an instance in which the duct 21 has, for example, a bellows shape.

Each of the first slide surface 58 and the second slide surface 59 is parallel to the virtual straight-line L extending in the moving direction Dm and is provided so as to encompass the virtual straight-line L. It is therefore possible to efficiently cause the fluid to flow compared with an instance in which, for example, the first slide surface 58 and the second slide surface 59 intersect the virtual straight-line L.

The first duct 51 and the second duct 52 are able to move relative to each other in the orthogonal direction Do. Accordingly, the second duct 52 is able to follow the liquid ejecting head 19 even when the position of the liquid ejecting head 19 with respect to the housing 12 deviates in the orthogonal direction Do.

The second duct 52 readily slides in a state in which the second slide surface 59 is not in contact with the first slide surface 58 compared with a state in which the second slide surface 59 is in contact with the first slide surface 58. From this viewpoint, the first slide surface 58 and the second slide surface 59 are provided with the gap 75 therebetween, the gap 75 having a sufficient dimension to enable the fluid to pass therethrough. The second duct 52 is thus able to readily slide relative to the first duct 51.

Of the first slide surface 58 and the second slide surface 59, the first slide surface 58 arranged in an inner portion is constituted by a single member. Accordingly, even when the liquid ejecting apparatus 11 is reduced in size, the first slide surface 58 is readily bent and thus enables positional deviation of the liquid ejecting head 19 with respect to the housing 12.

Of the first slide surface 58 and the second slide surface 59, the second slide surface 59 arranged in an outer portion is constituted by plural members. It is therefore possible to easily increase the liquid ejecting apparatus 11 in size.

In the state in which the duct 21 is expanded, since the first thick tube section 78 and the second thin tube section 79 face each other, it is possible to narrow the gap 75 between the first duct 51 and the second duct 52, enabling a reduction in fluid leakage. In the state in which the duct 21 is contracted, since the second thin tube section 79 faces the first thin tube section 77 which is thinner than the first thick tube section, the gap 75 between the first duct 51 and the second duct 52 is widened, thus making it possible to easily slide the second duct 52 relative to the first duct 51.

The second coupling section 50 has elasticity and thus enables positional deviation of the liquid ejecting head 19.

The second coupling section 50 is provided between the first end 54 and the second end 56 of the duct 21. It is therefore possible to provide the second coupling section 50 close to the first end 54 compared with an instance in which, for example, the second coupling section 50 is provided in the second end 56.

The second coupling section 50 has the handle 67 provided in the tip end of the plate spring 66, and the plate spring 66 pushes the protrusion 68 against the liquid ejecting head 19. The operator is thus able to detach the protrusion 68 from the liquid ejecting head 19 by operating the handle 67 to deform the plate spring 66.

The liquid ejecting head 19 has the cover 43 that covers the signal generating circuit 42. Not only the duct 21 but also the cover 43 enables the fluid to flow therein. It is therefore possible to efficiently cool the signal generating circuit 42 by using the fluid flowing in the cover 43.

The pump 22 feeds the fluid into the duct 21 which may be in the expanded state, the contracted state, or in a state of being deformed. That is, the pump 22 is able to feed the fluid into the duct 21 regardless of the duct 21 state. It is therefore possible to cool the stopped liquid ejecting head 19 or the moving liquid ejecting head 19.

The second duct 52 includes the main body 61 having the groove 63 and the lid 62 having the protrusion 64. When the protrusion 64 is fit into the groove 63, the second duct 52 is able to reduce fluid leakage from a space between the main body 61 and the lid 62.

### Second Embodiment

Next, a second embodiment of the liquid ejecting apparatus will be described with reference to the drawings. Note that the second embodiment differs from the first embodiment in that a flexible member is provided. Since the other points are substantially the same as those of the first embodiment, the same constituents will be given the same reference numerals, and redundant description will be thereby omitted.

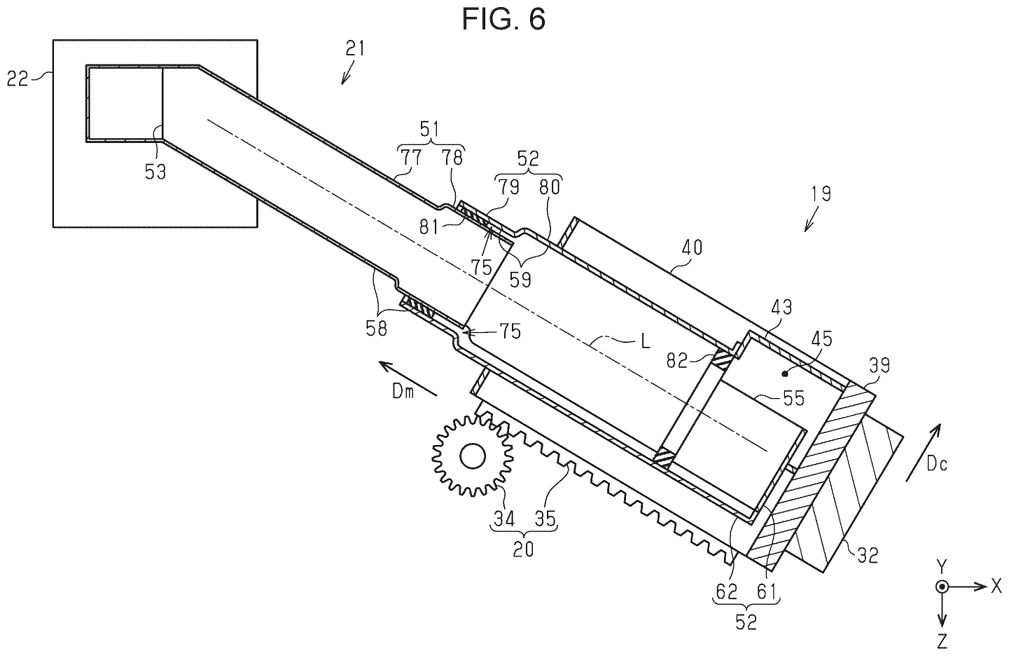

As illustrated in FIG. 6, the liquid ejecting apparatus 11 may include a first flexible member 81, which is an example of a flexible member. The liquid ejecting apparatus 11 may include a second flexible member 82, which is an example of a flexible member. The first flexible member 81 and the second flexible member 82 have flexibility.

Each of the first flexible member 81 and the second flexible member 82 is provided in the gap 75 and slides relative to one of the first slide surface 58 and the second slide surface 59. Specifically, the first flexible member 81 is wound around the first slide surface 58, which is the outer surface of the first thick tube section 78, and slides relative to the second slide surface 59. The second flexible member 82 is provided on the second slide surface 59, which is the inner surface of the second thick tube section 80, and slides relative to the first slide surface 58.

Operation of the present embodiment will be described.

As illustrated in FIG. 6, in the state in which the duct 21 is expanded, the first flexible member 81 is positioned in the gap 75 between the first thick tube section 78 and the second thin tube section 79. The first flexible member 81 closes the gap 75 and restricts a flow of the fluid passing through the gap 75.

When the second duct 52 moves in the moving direction Dm and the second thin tube section 79 leaves the first thick tube section 78, the first flexible member 81 also leaves the second slide surface 59. The second duct 52 thus moves in the moving direction Dm in a state in which friction between the first duct 51 and the second duct 52 is reduced.

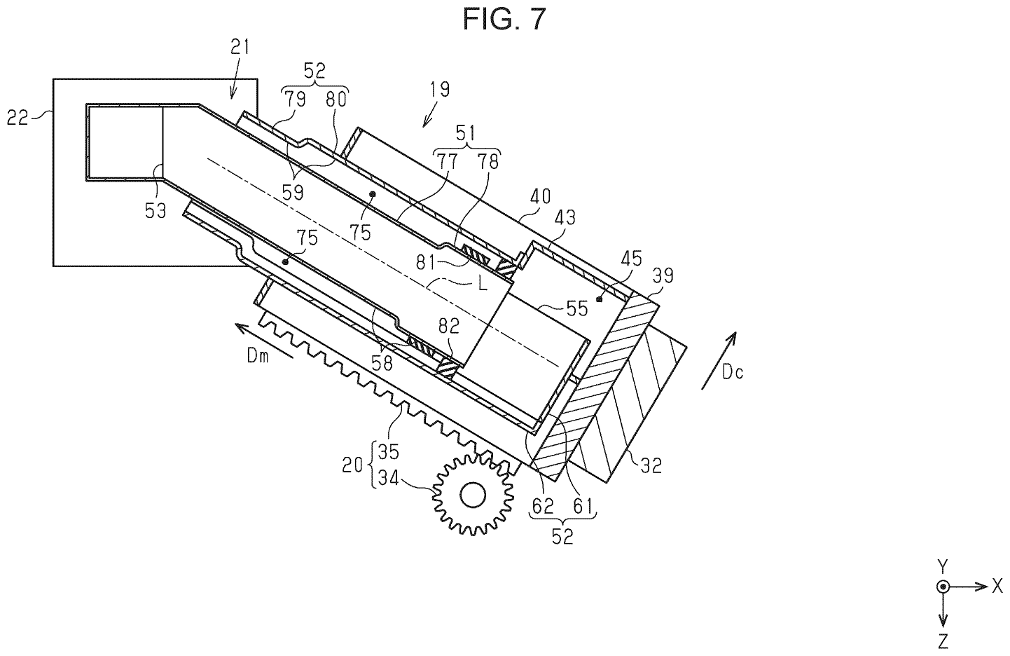

As illustrated in FIG. 7, in the state in which the duct 21 is contracted, the second flexible member 82 is positioned in the gap 75 between the first thick tube section 78 and the second thick tube section 80. The second flexible member 82 closes the gap 75 and restricts a flow of the fluid passing through the gap 75. When the first duct 51 and the second duct 52 move relative to each other in the orthogonal direction Do orthogonal to the virtual straight-line L, the first flexible member 81 and the second flexible member 82 are bent and deformed and enable the relative movement.

An effect of the present embodiment will be described.

The first flexible member 81 and the second flexible member 82 that are provided in the gap 75 are able to enable movement of the second duct 52 following the liquid ejecting head 19 even when the position of the liquid ejecting head 19 with respect to the housing 12 deviates in the orthogonal direction Do.

The present embodiment is able to be modified and implemented in the following manner. The present embodiment and the following modified examples may be implemented in combination within a range in which they do not technically contradict each other.

The moving mechanism 20 may have a rail (not illustrated) which guides movement of the liquid ejecting head 19. The rail may be linear or curved. The moving direction Dm may extend along the curved rail.

The moving mechanism 20 may move the liquid ejecting head 19 by fixing the liquid ejecting head 19 to an annular belt and causing the belt to circulate. The moving mechanism 20 may move the liquid ejecting head 19 so as to raise the liquid ejecting head 19, for example, by using a winch. The moving mechanism 20 may move the liquid ejecting head 19 so as to push the liquid ejecting head 19 up, for example, by using a jack.

The pump 22 may feed the fluid into the duct 21. In this instance, the inlet 55 into which the fluid flows is provided in the first duct 51, and the outlet 53 from which the fluid flows out is provided in the second duct 52. The fluid may flow from the duct 21 into the channel 45 and be discharged from the first opening 46.

The main body 61 may have the protrusion 64, and the lid 62 may have the groove 63.

The duct 21 may be a circular tube having a circular section.

The pump 22 may feed the fluid into the duct 21 in at least one of the expanded state, the contracted state, and the state of being deformed.

The pump 22 may be provided inside the duct 21.

The duct 21 may include a plurality of one-way valves provided therein. Each of the one-way valves enables a flow of the fluid in a single direction and restricts a flow of the fluid in other directions. The duct 21 may cause the fluid to flow by taking the fluid from the inlet 55 at a time of expanding and by feeding the taken fluid from the outlet 53 at a time of contracting.

The duct 21 is not necessarily coupled to the cover 43. The cover 43 does not necessarily form the channel 45.

The second coupling section 50 may fix the second duct 52 to the liquid ejecting head 19 without using the plate spring 66.

The second coupling section 50 may be provided in the second end 56 of the duct 21.

The first duct 51 may have constant thickness from one end to the other end.

The second duct 52 may have constant thickness from one end to the other end.

The second duct 52 may be constituted by a single member.

The first duct 51 may be constituted by plural members.

The first slide surface 58 and the second slide surface 59 may be in contact with each other.

The first duct 51 may be arranged outside the second duct 52.

The duct 21 may have a bellows shape. The duct 21 may be formed of a single member from the first end 54 to the second end 56.

A fluid flowing in the duct 21 is not limited to gas such as air and may be liquid such as water. When liquid is used, the inlet 55 and the outlet 53 may be coupled to the pump 22, and a portion of the duct 21 may be coupled to the liquid ejecting apparatus 11.

The liquid ejecting apparatus 11 may be a liquid ejecting apparatus that discharges or ejects liquid other than ink. The liquid to be ejected as droplets of a minute amount of liquid from the liquid ejecting apparatus may be in, for example, a granular state, a teardrop state, or a tailing thread-like state. Any material is applicable to the liquid here as long as the material is able to be ejected from the liquid ejecting apparatus. For example, any liquid is applicable as long as a substance thereof is in a liquid phase, and examples of the liquid include a liquid material having high or low viscosity and a fluid such as a sol, gel water, other inorganic solvents, an organic solvent, a solution, a liquid resin, liquid metal, or metal melt. The liquid includes not only a liquid as one state of a substance but also one in which particles of a functional material formed of a solid substance such as a pigment or metal particles are dissolved, dispersed, or mixed in a solvent. Representative examples of the liquid include ink as described in the aforementioned embodiments and liquid crystal. Here, the ink includes general water-based inks and oil-based inks, and various liquid compositions such as gel ink and hot melt ink. Specific examples of the liquid ejecting apparatus include an apparatus that ejects liquid containing, in a dispersed or dissolved manner, a material, such as an electrode material or a coloring material, which is used for, for example, manufacturing a liquid crystal display, an electroluminescent display, a surface emitting display, or a color filter. The liquid ejecting apparatus may be an apparatus that ejects a bioorganic substance used for manufacturing biochips, an apparatus that is used as a precision pipette and ejects liquid serving as a sample, a printing apparatus, or a micro-dispenser, for example. The liquid ejecting apparatus may be an apparatus that ejects lubricant onto a precision machine such as a watch or a camera with pinpoint accuracy or an apparatus that ejects, onto a substrate, a transparent liquid resin such as an ultraviolet curing resin to form, for example, a micro hemispherical lens or an optical lens used in an optical communication element or the like. The liquid ejecting apparatus may be an apparatus that ejects etchant for acid etching, alkaline etching, or the like to etch a substrate or the like.

Technical ideas and effects obtained from the above-described embodiments and modified examples will be described below.

A liquid ejecting apparatus includes: a liquid ejecting head that includes a nozzle surface on which a nozzle is open and that ejects a liquid through the nozzle; a housing that accommodates the liquid ejecting head; a moving mechanism that moves the liquid ejecting head relative to the housing in a moving direction intersecting the nozzle surface; and a duct in which a fluid flows, in which the duct includes a first coupling section coupled to the housing and a second coupling section coupled to the liquid ejecting head and is configured to expand and contract in the moving direction.

According to the configuration, the duct coupled to the housing and the liquid ejecting head is able to expand and contract in the moving direction. Accordingly, the duct expands/contracts in response to movement of the liquid ejecting head in the moving direction. It is therefore possible to cool the moving liquid ejecting head.

In the liquid ejecting apparatus, the duct may include a first duct including the first coupling section and a second duct including the second coupling section, the first duct may enable the fluid to flow between the housing and the second duct, and the second duct may enable the fluid to flow between the first duct and the liquid ejecting head and may slide relative to the first duct in accordance with movement of the liquid ejecting head relative to the housing.

According to the configuration, the duct expands/contracts when the second duct slides relative to the first duct. It is therefore possible to reduce possible deformation of the duct compared with an instance in which the duct has, for example, a bellows shape.

In the liquid ejecting apparatus, the first duct may include a first slide surface, the second duct may include a second slide surface facing the first slide surface, and the first slide surface and the second slide surface may be parallel to a virtual straight-line extending in the moving direction and be provided so as to encompass the virtual straight-line.

According to the configuration, the first slide surface and the second slide surface are parallel to the virtual straight-line extending in the moving direction and are provided so as to encompass the virtual straight-line. It is therefore possible to efficiently cause the fluid to flow compared with an instance in which, for example, the first slide surface and the second slide surface intersect the virtual straight-line.

In the liquid ejecting apparatus, the first slide surface and the second slide surface may be provided with a gap therebetween in an orthogonal direction orthogonal to the virtual straight-line, and the first duct and the second duct may be configured to move relative to each other in the orthogonal direction.

According to the configuration, the first duct and the second duct are able to move relative to each other in the orthogonal direction. Accordingly, the second duct is able to follow the liquid ejecting head even when the position of the liquid ejecting head with respect to the housing deviates in the orthogonal direction.

In the liquid ejecting apparatus, the first slide surface and the second slide surface may be provided with the gap therebetween, the gap having a sufficient dimension to enable the fluid to pass therethrough.

The second duct readily slides in a state in which the second slide surface is not in contact with the first slide surface compared with a state in which the second slide surface is in contact with the first slide surface. From this viewpoint, according to the configuration, the first slide surface and the second slide surface are provided with the gap therebetween, the gap having a sufficient dimension to enable the fluid to pass therethrough. The second duct is thus able to readily slide relative to the first duct.

The liquid ejecting apparatus may further include a flexible member, and the flexible member may be provided in the gap and slide relative to one of the first slide surface and the second slide surface.

According to the configuration, the flexible member provided in the gap is thus able to enable movement of the second duct following the liquid ejecting head even when the position of the liquid ejecting head with respect to the housing deviates in the orthogonal direction.

In the liquid ejecting apparatus, of the first slide surface and the second slide surface, one that is arranged in an inner portion may be constituted by a single member.

According to the configuration, of the first slide surface and the second slide surface, one that is arranged in an inner portion is constituted by a single member. Accordingly, even when the liquid ejecting apparatus is reduced in size, the slide surface arranged in an inner portion is readily bent and thus enables positional deviation of the liquid ejecting head with respect to the housing.

In the liquid ejecting apparatus, of the first slide surface and the second slide surface, one that is arranged in an outer portion may be constituted by plural members.

According to the configuration, of the first slide surface and the second slide surface, one that is arranged in an outer portion is constituted by plural members. It is therefore possible to easily increase the liquid ejecting apparatus in size.

In the liquid ejecting apparatus, the first duct may include a first thin tube section and a first thick tube section thicker than the first thin tube section, the second duct may include a second thin tube section and a second thick tube section thicker than the second thin tube section, the first thick tube section may be positioned between the first thin tube section and the liquid ejecting head and is thinner than the second thin tube section, the second thick tube section may be positioned between the second thin tube section and the liquid ejecting head, the first thick tube section and the second thin tube section may face each other in a state in which the duct is expanded, and the first thin tube section and the second thin tube section may face each other in a state in which the duct is contracted.

According to the configuration, in the state in which the duct is expanded, since the first thick tube section and the second thin tube section face each other, it is possible to narrow the gap between the first duct and the second duct, enabling a reduction in fluid leakage. In the state in which the duct is contracted, since the second thin tube section faces the first thin tube section which is thinner than the first thick tube section, the gap between the first duct and the second duct is widened, thus making it possible to easily slide the second duct relative to the first duct.

In the liquid ejecting apparatus, the second coupling section may have elasticity.

According to the configuration, the second coupling section has elasticity and thus enables positional deviation of the liquid ejecting head.

In the liquid ejecting apparatus, the duct may include a first end in which an outlet is open and a second end in which an inlet is open, and the second coupling section may be provided between the first end and the second end.

According to the configuration, the second coupling section is provided between the first end and the second end of the duct. It is therefore possible to provide the second coupling section close to the first end compared with an instance in which, for example, the second coupling section is provided in the second end.

In the liquid ejecting apparatus, the second coupling section may include a plate spring having elasticity, a handle provided in a tip end of the plate spring, and a protrusion placed over the liquid ejecting head, and the plate spring may push the protrusion against the liquid ejecting head.

According to the configuration, the second coupling section has the handle provided in the tip end of the plate spring, and the plate spring pushes the protrusion against the liquid ejecting head. An operator is thus able to detach the protrusion from the liquid ejecting head by operating the handle to deform the plate spring.

In the liquid ejecting apparatus, the liquid ejecting head may include a drive element driven such that the liquid is ejected from the nozzle, a signal generating circuit that generates a driving waveform signal to be applied to the drive element, and a cover that covers the signal generating circuit, and not only the duct but also the cover may enable the fluid to flow therein.

According to the configuration, the liquid ejecting head has the cover that covers the signal generating circuit. The duct and the cover enables the fluid to flow therein. It is therefore possible to efficiently cool the signal generating circuit by using the fluid flowing in the cover.

The liquid ejecting apparatus may further include a pump that feeds the fluid into the duct, and the pump feeds the fluid into the duct which may be in an expanded state, a contracted state, or in a state of being deformed.

According to the configuration, the pump feeds the fluid into the duct which may be in the expanded state, in the contracted state, or in a state of being deformed. That is, the pump is able to feed the fluid into the duct regardless of the duct state. It is therefore possible to cool the stopped liquid ejecting head or the moving liquid ejecting head.

Hereinafter, a recording system will be described with reference to the drawings.

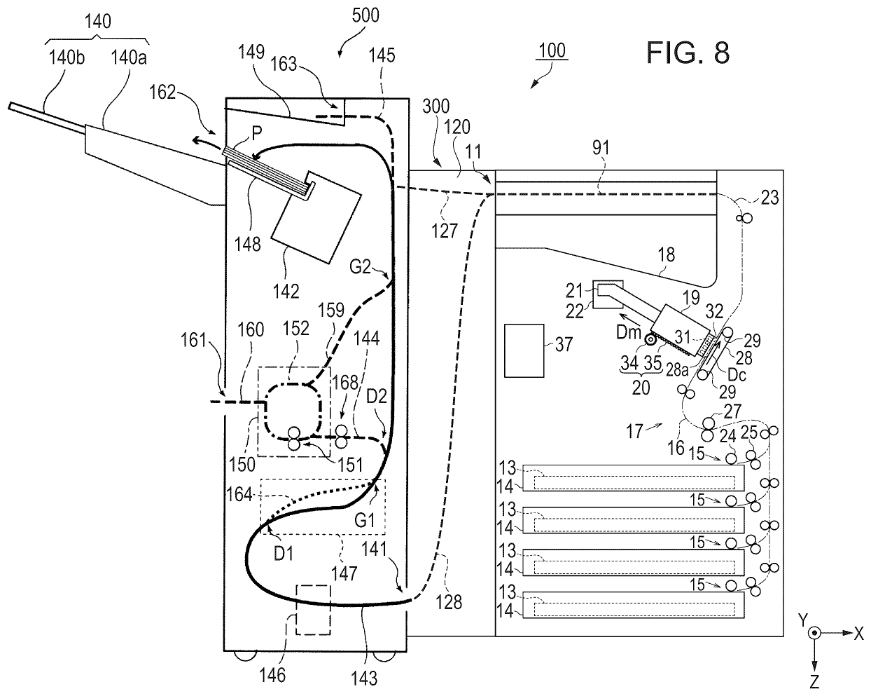

A recording system 100 illustrated in FIG. 8 includes, as an example, a liquid ejecting apparatus 11 liquid ejecting apparatus 11, an intermediate unit 300, and a first unit 500 as the medium processing apparatus, in an order from the right side to the left side of FIG. 8.

The first unit 500 is provided with a medium drying device 150 that performs drying processing on a received medium and an end stitching unit 42 that performs end stitching processing of bundling media on which recording has been performed by the liquid ejecting apparatus 11 and stitching ends of the media. The end stitching unit 142 is an example of a processing unit that performs processing on the medium received by the first unit 500.

The intermediate unit 300 receives the medium, on which recording has been performed, from the liquid ejecting apparatus 11 to send the medium to the first unit 500. The first unit 500 performs processing, such as the drying processing and the end stitching processing, on the received medium.

Hereinafter, the intermediate unit 300, the first unit 500 (the medium processing apparatus), and the medium drying device 150 will be described in detail in order.

The intermediate unit 300 will be described with reference to FIG. 8. The intermediate unit 300 illustrated in FIG. 8 delivers the medium received from the liquid ejecting apparatus 11 to the first unit 500. The intermediate unit 300 is disposed between the liquid ejecting apparatus 11 and the first unit 500. The medium transported through the second discharge path 23 and a bridge path 91 of the liquid ejecting apparatus 11 is received by the intermediate unit 300 from the reception path 120, and is transported to the first unit 500. Further, the reception path 120 is illustrated by a broken line of FIG. 8.

In the intermediate unit 300, there are two transport paths through which the medium is transported to the first unit 500. A transport path 127 is a path that extends in the −X direction from the reception path 120. A transport path 128 is a path that extends in the +Z direction and then in the −X direction from the reception path 120. The transport path 127 is shorter than the transport path 128.

The intermediate unit 300 receives the medium from the liquid ejecting apparatus 11 into the reception path 120 in a state where the surface on which the latest recording is performed by the liquid ejecting head 19 is headed to the lower side.

Thus, the medium in a state in which the latest recording surface is headed to the lower side is delivered from the −X direction of the intermediate unit 300 to a first transport path 143 of the first unit 500.

Further, in each of the reception path 30, the transport path 127, and the transport path 128, for example, one or more roller pairs that are not illustrated are arranged as a unit for transporting the medium.

In a case where the recording is performed by ejecting the ink (the liquid) to the medium as in the liquid ejecting head 19 of the present embodiment, when the processing is performed by the first unit 500 in a subsequent stage, if the medium is wet, the recording surface may be rubbed and the integrity of the medium may be poor.

By delivering the medium, on which recording has been performed, from the liquid ejecting apparatus 11 via the intermediate unit 300 to the first unit 500, a transport time required for the medium on which recording has been performed to be sent to the first unit 500 can be made long, and the medium can be further dried by the time the medium reaches the first unit 500.

Subsequently, the first unit 500 (the medium processing apparatus) will be described. The first unit 500 illustrated in FIG. 8 includes a receiving portion 141 that receives the medium from the intermediate unit 300 on the lower side in a +X direction. The medium transported along the transport path 128 of the intermediate unit 300 is input into the first unit 500 from the receiving portion 141 and is delivered to the first transport path 143.

The first unit 500 includes the drying unit 150 as the first processing unit that processes the medium received from the receiving portion 141 and the end stitching unit 142 as the second processing unit that processes the medium received from the receiving portion 141 or the medium processed by the drying unit 150.

The first unit 500 includes the first transport path 143 through which the medium received from the receiving portion 141 is sent to the end stitching unit 142 and a second transport path 144 which branches from the first transport path 143 at a second branching portion D2 and through which the medium is sent to the drying unit 150. The second branching portion D2 is provided with a flap that is not illustrated and switches a destination of the medium between the first transport path 143 and the second transport path 144.

For example, the end stitching unit 142 is a component that performs the end stitching processing of stitching the end of the medium, such as one corner of the medium and one side of the medium. For example, the end stitching unit 142 includes a stapler.

The drying unit 150 is a component that performs the drying processing on the medium. In the present embodiment, the drying unit 150 dries the medium by heating the medium. Although a detailed configuration of the drying unit 150 will be described later, the medium drying-processed by the drying unit 150 is sent to the end stitching unit 142.

Further, as illustrated in FIG. 8, the first unit 500 includes a punching processing unit 146 that performs punching processing on the medium received from the receiving portion 141. The punching processing unit 146 is installed at a position, close to the receiving portion 141, of the first transport path 143 through which the medium received by the first unit 500 passes, and is configured to be able to perform the punching processing upstream of the first transport path 143.

The medium received from the receiving portion 141 can be sent to a processing tray 148 through the first transport path 143 illustrated in FIG. 8. The medium sent to the processing tray 148 may or may not have been punched by the punching processing unit 146. In the processing tray 148, the media are stacked on the processing tray 148 while rear ends of the media in a transport direction are aligned with each other. When a predetermined number of media P are stacked on the processing tray 148, the end stitching processing by the end stitching unit 142 is performed at rear ends of the media P. The first unit 500 includes a second discharge section 162 that discharges the medium in the −X direction. Further, the first unit 500 includes a first discharge section 161 and a third discharge section 163, which will be described below, in addition to the second discharge section 162, and is configured to discharge the medium from these sections.

The medium processed by the end stitching unit 142 (the second processing unit) is discharged from the second discharge section 162 to the outside of the medium processing apparatus of the first unit 500 by a discharge unit which is not illustrated, and is placed on a first tray 140 as a tray that receives the medium discharged from the second discharge section 162. The first tray 140 is provided to protrude from the first unit 500 in the −X direction. In the present embodiment, the first tray 140 includes a base portion 140a and an extension portion 140b, and the extension portion 140b is configured to be accommodatable in the base portion 140a.

Further, a third transport path 145 branching from the first transport path 143 at a third branching portion D3 downstream of the second branching portion D2 is coupled to the first transport path 143. The third branching portion D3 is provided with a flap that is not illustrated and switches a destination of the medium between the first transport path 143 and the third transport path 145.

An upper tray 149 is provided at an upper portion of the first unit 500. The third transport path 145 extends from the third branching portion D3 to the third discharge section 163 described above, and the medium transported through the third transport path 145 is discharged from the third discharge section 163 to the upper tray 149 by a discharge unit which is not illustrated. The medium punching-processed by the punching processing unit 146 can be placed on the upper tray 149. Further, the medium on which no punching processing is performed and no processing is performed after the recording can be stacked.

The first transport path 143 is provided with an overlapping path 164 which branches from the first transport path 143 at a first branching portion D1 and is rejoined to the first transport path 143 at a first junction portion G1. The overlapping path 164 constitutes a stacking processing unit 147 that stacks two sheets of the media and sends the two media to the drying unit 150 or the end stitching unit 142. A leading medium transported in advance is sent to the overlapping path 164, and a trailing medium transported through the first transport path 143 are joined at the first junction portion G1, so that the leading medium and the trailing medium can be transported downstream of the first junction portion G1 while overlapping each other. Further, the stacking processing unit 147 may be configured to provide a plurality of overlapping paths 164 and to send three or more sheets of the media to the downstream while the media overlap each other.

Further, in the first unit 500, for example, one or more roller pairs, which are not illustrated, as a unit that transports the medium are arranged in each of the first transport path 143, the second transport path 144, and the third transport path 145.

Next, the drying unit 50 as the first processing unit will be described.

As illustrated in FIG. 8, the drying unit 150 includes a heat roller pair 151 as a drying processing unit that performs the drying processing of the medium and a loop-like transport path 152 that includes the heat roller pair 151 and can circumferentially transport the medium. The second transport path 144 branching from the first transport path 143 is joined to the loop-like transport path 152 upstream of the heat roller pair 151. Thus, the medium can be sent by a transport roller pair 168 provided in the second transport path 144 and can be introduced into the loop-like transport path 152.

The heat roller pair 151 is a roller pair that holds the medium by a drying driving roller driven by a driving source which is not illustrated and a drying driven roller driven to rotate by rotation of the drying driving roller.

In the present embodiment, the drying driving roller is configured to be heated.

Further, as in the present embodiment, in the heat roller pair 151, at least one of the drying driving roller and the drying driven roller constituting the heat roller pair 151 may be heated or only the drying driven roller may be heated.

Further, both the drying driving roller and the drying driven roller may be heated. When both the drying driving roller and the drying driven roller are heated, both surfaces of a paper sheet are heated, so that the paper sheet can be more certainly dried.

As described above, the medium sent from the intermediate unit 300 is input from the receiving portion 141 via the first transport path 143 to the second transport path 144 of the first unit 500 illustrated in FIG. 8 in a state in which the latest recording surface faces the lower side. Then, the medium is nipped by the heat roller pair 151 in a state in which the latest recording surface faces the lower side. Therefore, between the heat roller pair 151, the heated drying driving roller comes into contact with the latest recording surface of the medium. That is, since the latest recording surface can be directly heated, the medium can be effectively dried.

The loop-like transport path 152 is configured to transport the medium circumferentially. In FIG. 8, a one-dot chain line indicates a trajectory of the medium which is input into the loop-like transport path 152 from the second transport path 144 to make one revolution.

With the loop-like transport path 152, by circumferentially transporting the medium a plurality of times, the drying processing by the heat roller pair 151 can be performed a plurality of times. Therefore, the medium can be dried more reliably.

Further, by providing the loop-like transport path 152, an increase in the size of the apparatus can be suppressed without increasing the size of the transport path for performing the drying processing a plurality of times, as compared to, for example, a case where a plurality of the heat roller pairs 151 are provided in the transport path.

In the recording system 100, the heating by the heat roller pair 151 is controlled by the control unit 37. The control unit 37 can control the heating by the heat roller pair 151 according to the conditions. The conditions include, for example, the amount of the ink ejected to the medium during the recording by the liquid ejecting apparatus 11, whether the recording on the medium is the double-sided recording or the single-sided recording, the environmental conditions such as the temperature and the humidity during the drying, in addition to the type, the rigidity, the thickness, and the basis weight of the medium.

By controlling the heating by the heat roller pair 151 according to these conditions, the medium can be more properly dried. Control of the heating by the heat roller pair 151 includes, for example, whether the heating is performed, the temperature during the heating, whether or not to perform residual heat during the heating, a timing when the heating by the heat roller pair 151 starts.

A fourth transport path 159 is coupled to the loop-like transport path 152 illustrated in FIG. 8. The fourth transport path 159 is a path that is joined to the first transport path 143 at a second junction portion G2 and returns, to the first transport path 143, the medium drying-processed by the heat roller pair 151.

Further, a fifth transport path 160 is coupled to the loop-like transport path 152. The fifth transport path 160 is a path extending to the first discharge section 161 and is a path for feeding, along-X direction, the medium drying-processed by the heat roller pair 151.

Alternatively, the drying unit 50 may be configured not to have the loop-like transport path 52.

Further, in the present embodiment, the drying unit 150 for drying the medium by heating the medium from the outside has been described. However, the drying unit 150 may also be configured to dry the medium, for example, by blowing air to the medium.

Further, in the present embodiment, an apparatus in which a recording function is omitted from the recording system 100 may be regarded as a medium processing apparatus.

The transport path 127 transports the medium to the first transport path 143. The transport path 127 merges with the first transport path 143 at a position downstream of the second junction portion G2. Therefore, the medium transported on the transport path 127 does not pass through the drying unit 150.

The control unit 37 can select a path for transporting the medium according to the conditions. The conditions include, for example, the amount of the ink ejected to the medium during the recording by the liquid ejecting apparatus 11, whether the recording on the medium is the double-sided recording or the single-sided recording, the environmental conditions such as the temperature and the humidity during the drying, in addition to the type, the rigidity, the thickness, and the basis weight of the medium.

The control unit 37 transports the medium which needs to be dried by the drying unit 150 to the transport path 128 in the intermediate unit 300. The control unit 37 transports the medium which does not needs to be dried by the drying unit 150 to the transport path 127 in the intermediate unit 300.

Since the transport path 127 is shorter than the transport path 128, it is possible to shorten the transport time of the medium which does not needs to be dried by the drying unit 150. Therefore, it is possible to improve the throughput of the medium which does not needs to be dried by the drying unit 150.

In addition, the medium which does not needs to be dried in the drying unit 150 by lengthening the transport time may be transported from the transport path 128 to the first transport path 143 and may not be branched from the first transport path 143 to the second transport path 144.

Hereinafter, the present disclosure will be schematically described.

A medium processing apparatus according to a first aspect includes a intermediate unit receiving a medium, on which recording has been performed, from a liquid ejecting apparatus and a first unit performing processing to the medium received from the intermediate unit, wherein the first unit includes a drying unit that performs a drying processing on the medium and a processing unit that processes the medium, the intermediate unit includes a first transport path that transports the medium to the first unit without passing through the drying unit and a second transport path that transports the medium to the first unit through the drying unit.

In a second aspect according to the first aspect, the first transport path is shorter than the second transport path.

In a third aspect according to the first aspect or the second aspect, the drying unit includes a transport unit that transports a medium and one heating unit that heats the medium transported by the transport unit and is provided in a transport direction of the medium, and the medium is transported to a heating area by the heating unit a plurality of times.

In a fourth aspect according to the third aspect, the transport unit has a loop-like transport path including the heating area and configured to circumferentially transport the medium, and as the medium passes through the loop-like transport path, the medium passes through the heating area a plurality of times.

In a fifth aspect according to the third aspect or the fourth aspect, the heating unit includes a heating roller pair that holds the medium between a driving roller driven to rotate and a driven roller driven to rotate by the rotation of the driving roller and transports the medium, and one or both of the driving roller and the driven roller is heated.

In a sixth aspect according to the first aspect to the fifth aspect, the medium processing apparatus further includes a control unit, wherein the control unit select a path for transporting the medium according to a condition.

An recording system according to an seventh aspect includes a liquid ejecting apparatus that performs recording on a medium and the medium processing apparatus according to the first aspect to the sixth aspect, wherein the liquid ejecting apparatus includes a liquid ejecting head that includes a nozzle surface on which a nozzle is open and that ejects a liquid through the nozzle, a housing that accommodates the liquid ejecting head, a moving mechanism that moves the liquid ejecting head relative to the housing in a moving direction intersecting the nozzle surface, and a duct in which a fluid flows, and the duct includes a first coupling section coupled to the housing and a second coupling section coupled to the liquid ejecting head and is configured to expand and contract in the moving direction.

What is claimed is:

1. A medium processing apparatus comprising:
a intermediate unit receiving a medium, on which recording has been performed, from a liquid ejecting apparatus; and
a first unit performing processing to the medium received from the intermediate unit, wherein
the first unit includes
a drying unit that performs a drying processing on the medium and
a processing unit that processes the medium,
the intermediate unit includes
a first transport path that transports the medium to the first unit without passing through the drying unit and
a second transport path that transports the medium to the first unit through the drying unit.

2. The medium processing apparatus according to claim 1, wherein
the first transport path is shorter than the second transport path.

3. The medium processing apparatus according to claim 1, wherein
the drying unit includes
a transport unit that transports a medium and
one heating unit that heats the medium transported by the transport unit and is provided in a transport direction of the medium, and
the medium is transported to a heating area by the heating unit a plurality of times.

4. The medium processing apparatus according to claim 3, wherein
the transport unit has a loop-like transport path including the heating area and configured to circumferentially transport the medium, and
as the medium passes through the loop-like transport path, the medium passes through the heating area a plurality of times.

5. The medium processing apparatus according to claim 3, wherein
the heating unit includes a heating roller pair that holds the medium between a driving roller driven to rotate and a driven roller driven to rotate by the rotation of the driving roller and transports the medium, and one or both of the driving roller and the driven roller is heated.

6. The medium processing apparatus according to claim 1, further comprising:
a control unit, wherein
the control unit select a path for transporting the medium according to a condition.

7. A recording system comprising:
a liquid ejecting apparatus that performs recording on a medium; and
the medium processing apparatus according to claim 1, wherein
the liquid ejecting apparatus includes
a liquid ejecting head that includes a nozzle surface on which a nozzle is open and that ejects a liquid through the nozzle,
a housing that accommodates the liquid ejecting head,
a moving mechanism that moves the liquid ejecting head relative to the housing in a moving direction intersecting the nozzle surface, and
a duct in which a fluid flows, and
the duct includes
a first coupling section coupled to the housing and
a second coupling section coupled to the liquid ejecting head and
is configured to expand and contract in the moving direction.
